(19) United States
(12) Patent Application Publication
(10) Pub. No.: US 2008/0109267 A1
(43) Pub. Date: May 8, 2008

(54) ONLINE STARTUP OF AN INNOVATION PROJECT

(75) Inventors: Deborah A. DeLosa, Brewster, NY (US); Paul T. Baffes, Austin, TX (US); James D. Jamison, Aurora, CO (US); Mary M. Keough, White Plains, NY (US); Kathleen Purdy, Richmond, VT (US); Kathleen M. Walsh, Laytonsville, MD (US)

Correspondence Address: INTERNATIONAL BUSINESS MACHINES CORPORATION;DEPT. 18G, BLDG. 300-482, 2070 ROUTE 52, HOPEWELL JUNCTION, NY, 12533, US

(73) Assignee: INTERNATIONAL BUSINESS MACHINES CORPORATION, Armonk, NY (US)

(21) Appl. No.: 11/555,871

(22) Filed: Nov. 2, 2006

(51) Int. Cl. G06Q 10/00

(52) U.S. Cl. 705/7

(57) ABSTRACT

computer-readable project information is stored in a computing system, such information being obtained from a user at a user computer in response to prompting the user to submit information addressing: (i) a need for a project; (ii) a goal of the project; (iii) a manner in which success of the project will be measured; and (iv) a need for collaboration on the project among participants drawn from outside customary organizational boundaries. To proceed with a project, computer-readable funding information is stored in the computing system which signifies approval of funding for the project. Then, a project definition is generated from at least the computer-readable project information inputted by the user and stored in a first database. Thereafter, information obtained from the stored project definition is displayed to users at user computers for recruiting participants to work on the project.

### BACKGROUND OF THE INVENTION

The present invention relates to computer-implemented project organization and execution. The present invention relates to, among others, computer-implemented methods for initiating, organization and/or managing an innovation project and for managing staffing for an innovation project.

The path to innovating a new product or service requires the coming together of efforts in many different disciplines. In addition to technical acumen, it takes marketing know-how, sound financial planning, and executive leadership to bring a new product or service to market. Such product or service innovation projects are necessarily a product of interdisciplinary collaboration.

Innovation projects undergo a series of planning and execution stages. Generally, an individual or core group first defines a concept for an innovation project. Then, others may help in evaluating the expected benefits and potential risks of engaging in the project. If the project concept passes muster, time and personnel are then formally allocated to it, often first only on a small-scale for validation purposes. Finally, once the feasibility of the product or service and investment in it are deemed worthwhile, an executive will commit the remaining resources needed to bring the new product or service to market.

Typically, the information required to plan and innovate new products and services is recorded and exchanged between people via traditional offline (pencil and paper type) methods, or similar methods assisted by standard or custom office automation products. Some such products which are widely used include Lotus® 1-2-3®, other Lotus brand products such as Approach®, Freelance®, NoteS™ and Wordpro™ (trademarks or registered trademarks of International Business Machines Corporation) and similar office automation products offered by Microsoft, Corel, etc., as well as financial applications such as Quicken®. However, the success of innovation projects managed by such pencil and paper type methods depends heavily upon each user's ability to seek out and obtain the full benefits of such office automation products. Apart from office automation, a project's success depends in large part upon a designated project leader's knowledge and experience in planning and executing a project.

Product and service innovation projects are staffed by corporate employees, contractors and/or consultants who typically work in one common location with frequent or occasional face-to-face interaction. The required speed of development and amount of resources allocated to the project usually dictate that the people involved work closely together.

However, sometimes skilled personnel are not available at one locality or are not available full-time to engage in such innovation project. In such case, a worthwhile project cannot be undertaken.

In addition, corporations and other employers often seek to improve the skills and morale of employees. On-the-job training is one time-honored way of improving skills. However, many employees perform the same job for months or years at a time and have little opportunity to develop other skills or interact with people outside of their normal circle. Assigning employees only projects within their usual responsibility in their own localities might not satisfy some employees and limit the growth of their careers. Indeed, some companies have policies encouraging or requiring their scientists and engineers to spend some part of their time on projects that do not fall within their usual job responsibilities. However, employees have to seek out something to do, perhaps by word of mouth, other times by self-directed efforts alone.

Many employees want to contribute to innovation projects, but are constrained due to current job responsibilities. There is no business model or infrastructure available to employees identify innovation projects outside the primary organization into which the employee fits for matching up employees' skills and willingness to participate in product and service innovation projects without requiring employees to leave their current jobs.

### SUMMARY OF THE INVENTION

A computer-implemented method of initiating a project is provided in which computer-readable project information is stored in a computing system, such information being obtained from a user at a user computer in response to prompting the user to submit information addressing: (i) a need for a project; (ii) a goal of the project; (iii) a manner in which success of the project will be measured; and (iv) a need for collaboration on the project among participants drawn from outside customary organizational boundaries. To proceed with a project, computer-readable funding information is stored in the computing system which signifies approval of funding for the project. Then, a project definition is generated from at least the computer-readable project information inputted by the user and stored in a first database. Thereafter, information obtained from the stored project definition is displayed to users at user computers for recruiting participants to work on the project.

### BRIEF DESCRIPTION OF THE DRAWINGS

FIG. 1 is a block diagram illustrating a networked computing system environment which supports methods of initiating and staffing projects in accordance with embodiments of the invention.

FIG. 2 is a flowchart illustrating a method of initiating a project in accordance with an embodiment of the invention.

FIG. 3 is a flowchart illustrating a method of staffing a project in accordance with an embodiment of the invention.

### DETAILED DESCRIPTION

Accordingly, a goal of the embodiments of the invention disclosed herein is to facilitate matching of employees' skills with innovation projects that need not be within the primary organizations into which employees fit. A computer-implemented method and system are provided which address these needs and promote successful innovation projects by employees who can participate in them from remote or local work locations. Voluntary (employee-initiated) participation and participation from remote work locations are encouraged, and employees need only commit to part-time participation.

Moreover, the methods and systems described herein benefit the employer by enabling greater research and development projects to be undertaken by matching up skills of motivated employees with projects outside the primary organizations to which they report. In one preferred embodiment, a team of six to eight employees from diverse nationwide or even international work locations commit twenty percent of their time to participating in furthering the innovation project, usually on a one day per week basis for nine to 12 months.

The goals of the project can be limited to validating or demonstrating project concepts or, depending upon the project or service being developed, can include the development of a prototype. A senior technical leader, having superior skills in managing a project and organizing and directing efforts, leads participants towards achieving the project's goals. When the project is completed, the results are presented to an executive who can then decide whether to continue pursuing the project with the same team of remote participants, or devote additional resources to bringing a new product or service to the market. At this point, the team may be invited to showcase the results of their project before executives and senior technical leaders.

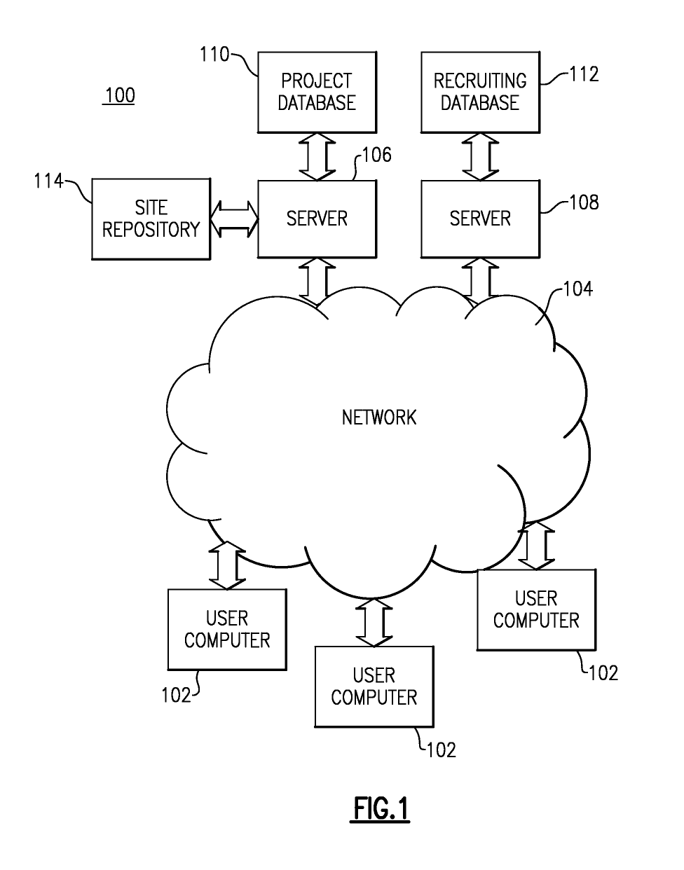

FIG. 1 is a block diagram illustrating the organization of an environment which supports methods of initiating, executing and/or staffing an innovation project in accordance with embodiments of the present invention. As depicted in FIG. 1, a plurality of user computers 102 are connectable through a network 104 to server computers 106 and 108. The network 104 can include one or more wired and/or wireless local area networks (“LANs”) such as Ethernet, token-ring, Infiniband, for example, one or more wide area networks (“WAN”) which may include wired broadband connections, e.g., cable and/or fiber-optic connections, and/or digital subscriber lines (“DSL”), integrated services digital network (“ISDN”), etc., and data transmission over plain old telephone service (“POTS”) and/or wireless digital broadband connections including but not limited to Bluetooth®, IEEE 802.11, Generalized Packet Radio Service (“GPRS”), Cellular Digital Packet Data (“CDPD”). Some of the nodes and links of the network can be part of an enterprise network or “intranet” managed by an organization or a corporation. Other nodes and links of the network can be part of a public network such as the Internet. The network can include one or more routers, bridges and intermediate servers (not shown), such as one or more proxy servers, for example. Preferably, the network implements the data communication protocol known as TCP/IP (“Transmission Control Protocol/Internet Protocol”), and may also implement one or more alternative data communication protocols such as, for example, asynchronous transfer protocol (“ATM”), IPX and Infiniband, among others.

Server computers 106 and 108 (hereinafter, “servers”) receive information regarding projects from users of the user computers. The servers 106, 108 are connected to databases 110, 112 which provide storage for information of various types. Server 106, for example, makes available HTML encoded pages or other similar compatible hypertext terminal transfer protocol (“HTTP”) pages or information in form of a “site” (e.g., intranet site or website) for access by the user computers 102, e.g., through a webbrowser, e.g., Internet Explorer™, Mozilla Firefox™, Opera™, etc. Pages and related information to support the site are stored as a site repository in storage 114 available to server 114. In addition, server 106 receives information regarding projects initiated or being handled by users of user computers 102 and stores the information in a project database in storage accessible to the server 106. The project database contains computer-readable character information, which preferably is organized by fields to permit the sorting and querying of information stored therein. Optionally, the project database includes other information which need not be organized by fields, need not be character information and, while storable in the database, need not be readable by the computer except to be capable being stored, retrieved and/or output, e.g., by a printer, loudspeaker or display.

Similarly, server 108 receives information from users of user computers regarding their skills and willingness to participate an in innovation project. The server 108 collects this information from interested users of user computers 102 who register as candidates to participate in projects. Similar to server 106, server 108 enables users to access a subscriber site containing a set of pages with fillable forms for interested users to provide information regarding their skills and interests. Server 108 stores this information in a recruiting database. Server 108 preferably is programmed to notify subscribers, e.g., via e-mail, and/or via a page personalized to the registered subscriber, when a predetermined event occurs, e.g., when a predetermined date and time is reached, a new project proposal is stored to the project database 110, or a participant takes leave from or resigns from an active project. In this way, project participation is actively promoted to interested users on an ongoing basis and when projects are in known need of staffing.

While two servers are illustrated in FIG. 1, it is also possible to consolidate the functions of these servers in one server. Alternatively, a plurality of servers having access to the databases 110, 112 and site repository 114 can be utilized, each of the servers providing access to the information stored in the databases and capable of hosting the site in case of high demand or server failure.

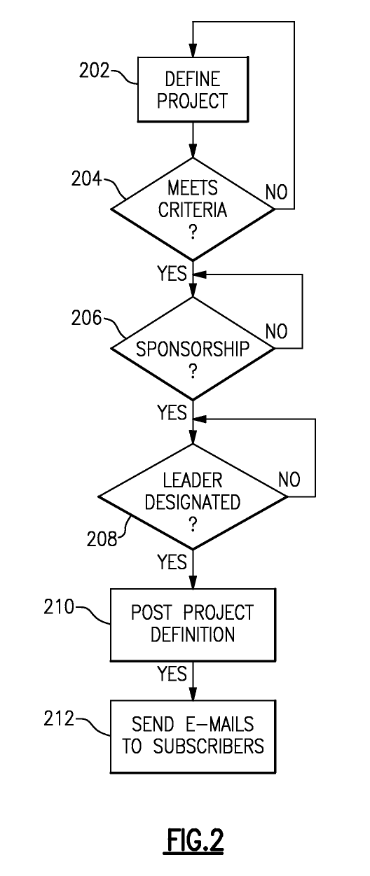

A method of initiating an innovation project will now be described with reference to FIG. 2. As discussed in the foregoing, a novel feature of the embodiments of the invention is freedom from having to recruit employees to participate in the project from a single functionally organized unit of an organization such as a corporation. Initiating a new project begins with a user entering information on a user computer 102 (FIG. 1) to define the project (step 202). In this step, a user proposing a new project is prompted to address several key issues. For one, the user is prompted to identify a need of the project for collaboration by participants drawn from outside customary organizational boundaries, i.e., from outside the user's functionally organized unit.

Typically, a user at one of the user computers 102 accesses the server site via a HTTP compliant browser running on that user computer, for example, by directly inputting a universal resource locator (“URL”) to the browser, or by clicking on a saved bookmark or clicking on a hypertext link from a page (e.g., an HTTP compliant page) displayed at that user computer 102. In response, the server distributes one or more pages, forms, etc., to that user computer 102, which the browser at that user computer then displays to the user as a page containing user prompts, buttons and hypertext links. In a particular embodiment, as displayed via the browser, the prompts are associated with input fields for the user to submit user input. Stated another way, each prompt appears on the screen in such a position as to guide the user to supply input to a corresponding input field in response thereto. Typically, the user provides such input by typing information into the input field and then clicks on a corresponding marked button on the page to continue. Alternatively, or in addition thereto, one or more prompts may permit or request the user to attach, upload or otherwise transmit computer-readable input, preferably in form of an internally indexable, searchable file, such as a word processor document, portable document format (“.pdf”) file, spreadsheet (e.g., “0.123” or “.xls”) file, presentation file (“.flg” or “.ppt”) file, or the like. In addition thereto, the displayed page can also prompt the user to input, e.g., attach, upload or otherwise transmit an internally non-searchable format file such as a bitmap file (“.bmp” format file) or compressed image file (e.g., “.gif”, “.jpg”, “.tif”) among others. In such way, the user inputs the requested information to the user computer and the user computer transmits the information back to the server computer 106 which then stores at least some of the inputted information in the project database 110.

As part of entering the project definition, the user is also prompted via one or more pages displayed by the browser to input computer-readable information addressing a business need for the project, such information defining a specific goal to be achieved. In addition, one or more displayed pages prompt the user to input computer-readable information describing how the success of the project will be measured. Again, the user inputs such information to the user computer and the user computer transmits the information back to the server computer 106 which then stores at least some of the inputted information in the project database 110.

Preferably, when inputting information to define the project, the user is asked a set of specific questions. The inventors have found that certain properly phrased and appropriately focused questions can prompt users to provide a clearer statement of the customer problem to be addressed, and more clearly state the goal of the project, the business and technical goals and a transition plan for realistically implementing the project. This has been effectively used to communicate project descriptions to all stakeholders, from executive level management to technical employees. It requires the idea submitter to think not only of the technical goals, but also to define revenue opportunities and customer wants and needs.

Thus, the following are among the questions preferably posed to the user by prompts displayed on the user computer. The first set of questions relate to the initial definition of the project. These include:

What is the key issue that motivates the need for this project?

What part of the key issue is going to be addressed?

How will success of the project be measured?

How will the project's results be used once it is completed?

What are the key technical and business goals of the project?

Preferably, when defining the project the user is prompted to submit information, if available, regarding the following: definition of business skills likely to be needed for the project; analysis of market opportunities and market sizing estimates such as may be obtained using market intelligence techniques; information regarding segmentation of the market, if any; analysis of customer requirements and buying behavior; basic financial concepts and assumptions made for developing an estimated process and loss statement for the project; business plan development; position relative to competitors and knowledge of competitive trends; strategies for bringing the product or service to the market; techniques for managing further planning, if any, and execution of the project; development of a strategy for carrying out the project; development of a business concept with emphasis on leveraging technology; knowledge relating to customary market planning processes; knowledge of other product or services offerings and/or technology in an area to which the project belongs; and/or the definition of technical skills needed to carry out the project's goals.

Here, the technical skills definition can include skills relating to several disciplines and can refer to either broadly-defined skills, specific skills or both broadly-defined and specific skills. As applied to the development of new products and/or services in the computer industry, for example, the technical skills definition may include, among others, skills for developing certain computer-related and/or data communications related hardware, and/or operating systems, firmware, software, etc. For example, the technical skills definition may include references to particular computer applications and/or operating systems and/or reference to specific types of data or programs. For example, the technical skills definition may include a requirement for skills to perform one or more of the following: develop applications using databases; develop applications using Linux; develop applications using Windows; develop applications using XML; develop applications using web services; develop applications using grid computing; develop Java applications; develop J2EE applications; develop C++ applications; develop C applications; and/or develop human/computer interfaces.

As a further example, the technical skills definition may list as a requirement one or more of the following: knowledge of systems programming; knowledge of Linux internals; knowledge of computer security and cryptography; and/or knowledge of artificial intelligence.

In this or another example, the technical skills definition can indicate one or more of the following technical skills as needed or desired for the project: develop applications using mobile computing; develop applications using DB2; develop applications using Cloudscape®; develop applications using Websphere®; develop applications using Websphere MQ®; develop applications using Websphere Portal®; develop applications using Eclipse; develop applications using Websphere Studio® (registered trademarks of International Business Machines Corporation); and develop applications using modeling tools. Alternatively or in addition thereto, the technical skills definition may list other specific required technical skills.

The invention provides an innovative approach for ensuring the project is aligned with the strategy and goals of the corporation and obtains effective technical leadership for its execution. Preferably, a simple set of criteria are applied to help select the best projects to proceed, while promoting a method which allows a theoretically unlimited number of projects to go ahead. The criteria were deliberately made simple in order to encourage maximum participation by different units of the corporation, even units from different geographies. Testing the projects against the simple criteria leads to the projects which have a high probability of achieving success.

The prompts displayed on the user computer via the site accessed from the server 106 direct the user to enter sufficient information to address three main criteria for going ahead with the project. These criteria include whether the project is innovative, whether the project requires “cross-unit” collaboration (collaboration across several different units of a corporation or organization), and whether the project will conclude in something having real proof points, e.g., a prototype or at minimum a vehicle for demonstrating proof of concept.

A project is innovative when it includes elements such as new technology, a new application of an existing technology or applies technology to a new market, for example. The innovation must also respond to a need of the business or customer.

The cross-unit collaboration requirement relates to whether the project requires skills of individuals drawn from multiple different units of the corporation or organization. Cross-unit collaboration enables participants from the different units to reach a solution which may be better integrated into the corporation's offerings and have broader appeal within the corporation. Another benefit is that participants in the project are given an opportunity to develop relationships with participants from other such units.

The determination of what qualifies as real “proof points” depends upon the character of the innovation project being undertaken. The nature of the deliverable to be provided is left fairly open to definition, but having a successful prototype increases chances of integrating the project into actual product development and market entry plans.

Initially, the project definition is tested against these criteria by a user or group of users who are inputting the project definition (step 204). Through use of the prompts and other educational resources provided through the site accessed from server 106 (FIG. 1), among others, the user or group of users become educated in defining a suitable project. With this information, the user can often determine when the defined project does not yet meet the above-described criteria. This is indicated by the “No” branch from block 204 which directs the user to return to block 202 to work on inputting information defining a suitable project. Alternatively, or in addition thereto, an evaluator of the project can review the user's submission at this point and either concur with the user or critique specific items that the user needs to address, such event also being indicated by the “No” branch from block 204 directing the user to return to the step of defining the project (step 202).

Once user and/or evaluator are satisfied that the project definition meets the criteria, sponsorship is sought (step 206). An innovative funding model is provided. A sponsor, usually an executive of the corporation, is identified who agrees to provide nominal funding, e.g., funding of approximately $45,000. Such amount covers basic infrastructure costs of the project, e.g., nominal fees paid for supplies and/or one-time services obtained from outside the company. In addition, the $45,000 fee covers travel costs required for all participants of the team to have up to three face-to-face meetings during execution of the project. Requiring an executive to provide at least nominal funding for the project is important to ensure that the executive takes ownership of the project and will seek to have the project executed in a way that is aligned with the strategy of the executive for growing his or her own unit of the corporation.

However, the time that each participant spends working on the project is paid for by the unit of the corporation in which that participant is employed. The local unit in which the participant is employed does not share in the out-of-pocket costs nor does that local unit share in the potential rewards to be reaped from the project. The participant's local unit obtains a different kind of benefit. Participants acquire new skills through their involvement in a project. Morale improves and participants bring new skills and enthusiasm back to their current jobs. Participants also develop a broader set of relationships across the corporation from which they can benefit themselves and their local units. A participant's local unit reaps these benefits from committing a portion of the employee's time to the project, usually 20% or one day a week.

Thus, sponsorship is a matter of an executive approving nominal infrastructure and travel costs for carrying out the project, and a commitment and determination of the participant's own local unit that the project is a worthwhile investment for the employee's development. With participants' local units funding the participants' time on a project, the project sponsor obtains virtually free resources. In return, participants obtain a proof point for a new growth opportunity in their careers. This funding approach leads to a streamlined way of bringing resources to bear on projects involving innovation, avoiding traditional processes such as committee review which could delay or interfere with the successful execution of some projects.

The “No” branch of block 206 indicates when sponsorship has not yet been approved for the project. The project does not proceed without an executive putting up the nominal fee. When sponsorship is approved, a highly skilled person is designated a senior technical leader for the project (step 208). The senior technical leader is responsible for the successful execution of the project and the results it obtains. Sometimes the senior technical leader is the same person who originally submits the definition of the project (step 202). However, that need not be so. The senior technical leader is a participant whose time is contributed by his or her own local unit in the manner described above. The senior technical leader must agree to lead the project one day per week for the duration of the project, usually nine to 12 months. Typically, a candidate for this position will apply informally to the executive sponsoring the project. Assuming that the executive has confidence in the candidate's qualifications, he or she need only send an e-mail commitment to the executive that he or she commits to taking on the role of senior technical leader. An e-mail from the manager of the candidate agreeing to the candidate's time commitment on the project is also required. These emails are stored as part of the record of the project in the project database 110.

Server 106 stores computer-readable information in the project database 110 (FIG. 1) which is representative of the project definition and of the commitments made by the executive to sponsor the project and by the senior technical leader to lead the participants in executing the project. The updating of the project database to store information regarding the particular newly sponsored, and leader-committed project is reflected in FIG. 2 as posting the project definition to the database (step 210). Once the project has obtained a sponsor and a senior technical leader and the project definition has been posted to the project database 110 (FIG. 1), the project is now ready to be staffed. Accordingly, participation in the project will now be promoted.

The project can be promoted in a variety of ways. In a particular example, the project is promoted through communications, e.g., e-mails to subscribers who are registered in advance (step 212). The system can promote all new projects broadly by generating and sending e-mails to all current subscribers. Alternatively, the system can take a more selective approach by generating and sending e-mails only to subscribers who select to be notified of certain types of projects.

In another example, the registered subscriber can maintain an individual user account at a website used to promote the project, e.g., a site operated by server 108 which provides individualized lists of projects to individual subscribers, as controlled via information stored in the recruiting database 112. Typically, the individual subscriber will then have log-in access to obtain a selection of projects which meet that individual's pre-registered selection criteria and preferences.

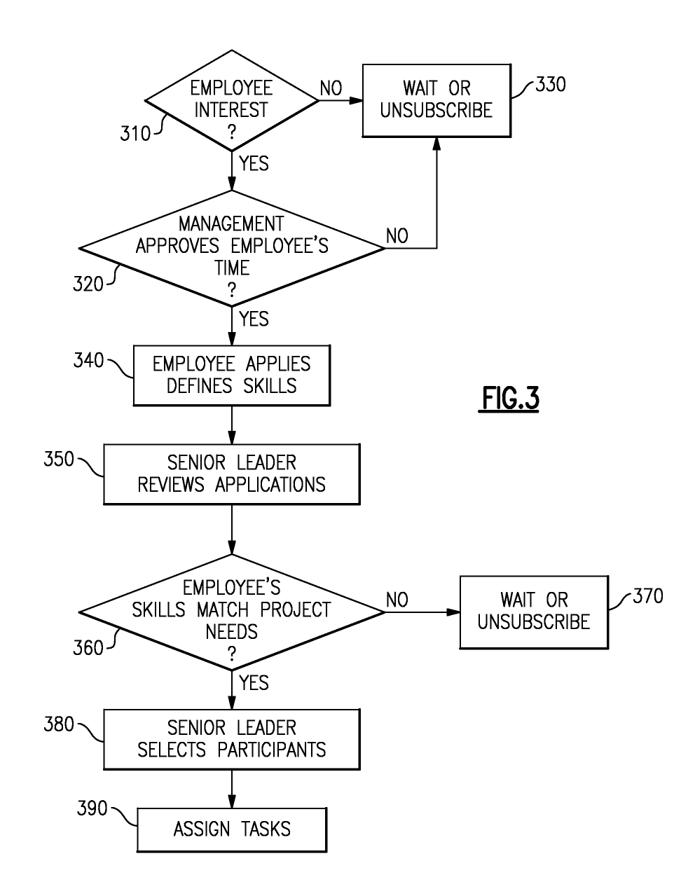

A method for staffing an innovation project will now be described, with reference to FIG. 3. Therefore, step 310 illustrates an initial stage of the method in which a given employee, having reviewed a posted project definition, decides whether he or she has interest in participating in the project. If the employee is interested, he or she informs his or her management and management then decides whether or not to approve the employee's participation in the project (step 320). As mentioned above, preferably the management of each participant in the project contributes, at its own expense, one day per week of the employee's time. Desirably, in its decision whether to approve the employee's participation, the employee's management should consider some hard to quantify factors such as the employee's career growth, enhanced morale and the potential for improved relationships between the employee and other employee's in different local units. When management approves the employee's time commitment to the project, prompts displayed via the accessed site at a user computer 102 direct management to memorialize the approval by sending an e-mail to the employee and to an address of a server, e.g., server 106, server 108, which may be the same server or a different server from that used to promote the project. Such e-mail will then be stored in a database, e.g., the project database 110 as a record indicating that the particular employee's management has approved his or her participation in the project. Alternatively, the employee's management can indicate approval via other electronic means, e.g., electronic signature or the like through a secure interface available to management, such as through log-in access at one of the user computers 102 to the site hosted by server 106.

When the employee is not particularly interested, the employee can wait for another project definition to be posted (step 330). If upon reviewing one or several such project postings, the employee is not interested in continuing to receive information about projects, he or she can unsubscribe (step 330). Another possibility is that management does not approve the employee's participation in the project. Such case, again, is indicated at step 330 in which the employee either waits to be notified of another project or unsubscribes from being notified.

Once the employee obtains the commitment from his or her management to participate in the project and it is duly memorialized, e.g., via e-mail or electronic signature, etc., as described above, the employee applies to the senior technical leader to participate. The employee describes his or her technical skills, background and interest in the project (step 340). Typically, the employee inputs this information in response to one or more prompts displayed in form of a page or a form on the screen of a user computer 102 when the employee is accessing the site through server 106 or server 108 (FIG. 1).

As indicated in step 350, the designated senior technical leader now accesses stored information in a database, e.g., project database 110 (FIG. 1), which contains applications of various candidate employees who wish to participate in the project. The senior technical leader reviews the applications and in step 360 determines whether a particular employee's skills match the needs of the project. If the answer is yes, the senior technical leader selects the employee to participate in the project (step 380). The employee can either already have the required skills or can demonstrate an interest and ability to acquire the needed skills, e.g., via additional education, during the course of executing the project. Alternatively, when the senior technical leader determines that the employee does not have the required skills, the employee will be notified so, and the employee can either wait for another project or unsubscribe from being notified of projects in the future (step 370).

Finally, as indicated in step 390, when the senior technical leader is confident in the employees he or she has selected to participate in the project, the senior technical leader can then begin assigning tasks to individual participants, thus setting the project in motion on a path to completion.

While the invention has been described in accordance with certain preferred embodiments thereof, many modifications and enhancements can be made thereto without departing from the true scope and spirit of the invention, which is limited only by the claims appended below.

What is claimed is:

1. A computer-implemented method of initiating a project, comprising:
(a) storing computer-readable project information in a computing system, the project information being obtained from a user of a user computer of a computing system in response to prompting the user to submit information addressing: (i) a need for a project; (ii) a goal of the project; (iii) a manner in which success of the project will be measured; and (iv) a need for collaboration on the project among participants drawn from outside customary organizational boundaries;
(b) storing computer-readable funding information in the computing system signifying approval of funding for the project;
(c) generating a project definition from at least the computer-readable project information and storing the project definition in a first database; and
(d) after performing said steps (a), (b) and (c), displaying information obtained from the stored project definition to users at user computers of the computing system to recruit participants for the project.

2. The computer-implemented method for initiating a project as claimed in claim 1, further comprising: (e) inputting computer-readable information to the computing system regarding designation of a leader for the project, wherein said step (d) is performed only after performing said step (e).

3. The computer-implemented method for initiating a project as claimed in claim 1, wherein said step (a) is performed for each of a plurality of projects, the method further comprising a step (e) of ranking information provided for each project in each of the categories (a) (i) through (iv) for completeness to determine which of the plurality of projects meets criteria for selection and display.

4. The computer-implemented method for initiating a project as claimed in claim 1, further comprising: (e) storing computer-readable skills information in the computing system, the skills information identifying skills required of participants in the project; (f) storing computer-readable candidate information in the computing system obtained in response to displaying the skills information for the project in prompts to users of the user computers; and (g) accessing the stored candidate information to select participants for staffing the project.

5. The computer-implemented method for initiating a project as claimed in claim 4, further comprising: (h) storing computer-readable commitment information in the computing system, the commitment information obtained by prompting a manager of a user identified by the stored candidate information to signify a commitment of the user's time to the project.

6. The computer-implemented method for initiating a project as claimed in claim 1, further comprising: (e) storing subscriber information identifying subscribers in a second database, wherein the step (d) displaying information includes: (f) accessing the subscriber information stored in the second database and displaying the information to subscribers identified by the accessed subscriber information.

7. The computer-implemented method for initiating a project as claimed in claim 1, wherein the step (a) of storing computer-readable project information is performed after displaying information on the user computer describing each of the categories (i) through (iv) of project information being sought.

8. The computer-implemented method for initiating a project as claimed in claim 1, wherein the information displayed on the user computer describing each of the categories (i) through (iv) is displayed via one or more hypertext-enabled pages accessed by the user computer from a server computer.

9. The computer-implemented method for initiating a project as claimed in claim 8, wherein the information displayed on the user computer describing each of the categories (i) through (iv) is displayed via an intranet site.

10. The computer-implemented method for initiating a project as claimed in claim 1, wherein the computer-readable funding information includes information signifying executive approval of travel expenses for the project.

11. The computer-implemented method for initiating a project as claimed in claim 1, further comprising: (e) identifying participants to staff the project; and (f) inputting computer-readable information to the computing system regarding work locations of the participants to facilitate collaboration by participants in the project remotely from different work locations.

12. The computer-implemented method for initiating a project as claimed in claim 1, further comprising: (e) inputting computer-readable information to the computing system to define a part-time commitment of time by participants in the project to promote part-time participation in the project.

13. A computer-implemented method of managing staffing for a project, comprising:
inputting computer-readable project information to a computing system including a plurality of networked computers in response to prompting by the computing system, the inputted project information identifying goals of a project, a business environment relating to the project, and skill requirements of personnel needed to advance the project;
automatically generating a project definition by the computing system from the inputted project information and storing the project definition in a first database;
distributing computer-readable information from the stored project definition from a first computer of the computing system to a plurality of user computers of the computing system to promote the project to a plurality of users at the plurality of user computers;
obtaining computer-readable candidate information at the plurality of user computers, the candidate information identifying skills of candidates willing to serve as the personnel;
managing recruitment of the candidates for the project via automatically assisting one or more recruitment functions by the computing system; and
automatically tracking progress of satisfying the skill requirements for personnel via the step of managing the recruitment.

14. The computer-implemented method of managing the staffing for a project as claimed in claim 13, wherein the inputted information regarding the business environment includes information regarding characteristics of a market to be served by the project.

15. The computer-implemented method of managing the staffing for a project as claimed in claim 13, wherein the step of obtaining computer-readable candidate information includes interactively querying the users of the plurality of user computers through a series of user prompts.

16. The computer-implemented method of managing the staffing for a project as claimed in claim 13, wherein the step of inputting computer-readable project information includes obtaining the computer-readable project information in response to a series of prompts to a project leader at a user computer of the computing system.

17. The computer-implemented method of managing the staffing for a project as claimed in claim 13, wherein the step of managing recruitment of the candidates includes automatically generating queries to managers of the candidates to determine whether the candidates are available to serve as the skilled personnel.
